(19) United States
(12) Patent Application Publication
(10) Pub. No.: US 2012/0268259 A1
(43) Pub. Date: Oct. 25, 2012

(54) Monitored ignition lock

(76) Inventors: Patricia J. Igel, Downers Grove, IL (US); Jeffrey M. Igel, Downers Grove, IL (US)

(21) Appl. No.: 13/066,681

(22) Filed: Apr. 21, 2011

(51) Int. Cl. B60R 25/00; B60R 25/10

(52) U.S. Cl. 340/426.11; 701/2; 701/1

(57) ABSTRACT

A monitored ignition system is provided. A monitored ignition lock unit is contained within a vehicle. The monitored ignition lock unit is in communication with a weight sensor in the driver's seat and a seatbelt detection feature of the vehicle. A monitored ignition lock managing system is contained remotely from the vehicle. The monitored ignition lock and the unit monitored ignition lock managing system are in wireless communication. The monitored ignition lock unit includes a handheld device and a receiving station. The handheld device includes a substance detector, such as a breathalyzer. A camera is aimed to photograph a user when engaged with the substance detector. The handheld device and the receiving station are connected via a tether. The tether is sized such that only a driver sitting relatively close to the monitored ignition lock unit docking can access the substance detector provided in the monitored ignition lock handheld device. If the user exceeds a predetermined reading from the substance detector, the vehicle is stopped from starting. Whether engine starting is allowed or disallowed, a message can be sent to the monitored ignition lock managing system.

### FIELD OF THE INVENTION

The present invention relates to automobile safety.

### BACKGROUND OF THE INVENTION

Drunk driving remains a national tragedy. In 2009, over 1.4 million drivers were arrested for driving under the influence of alcohol or narcotics. (Department of Justice (US), Federal Bureau of Investigation (FBI). “Crime in the United States 2009: Uniform Crime Reports”. Washington, DC (2010)). However, that accounts for less than one percent of the 159 million self-reported episodes of alcohol-impaired driving among United States adults each year. (Quinlan, K P; Brewer, R D; Siegel, P; Sleet, D A; Mokdad, A H; Shults, R A; Flowers, N. “Alcohol-impaired driving among U.S. adults, 1993-2002”. 28(4) American Journal of Preventive Medicine 346 (2005)).

In 2009, 10,839 people were killed in alcohol-impaired driving crashes, accounting for nearly one-third (32%) of all traffic-related deaths in the United States. (Dept of Transportation (US), National Highway Traffic Safety Administration (NHTSA). “Traffic Safety Facts 2009: Alcohol-Impaired Driving.” Washington, D.C. (2010)). Drivers with a blood alcohol concentration (BAC) of 0.08% or higher involved in fatal crashes were eight times more likely to have a prior conviction for driving while intoxicated than were drivers with no alcohol (8% and 1%, respectively). (Dept of Transportation (US), NHTSA. “Traffic Safety Facts 2009: Alcohol-Impaired Driving”. Washington, D.C. (2010)).

In addition, the statistics also bear out that due to lack of experience and responsibility, teen driving itself is inherently risky. In 2008, about 3,500 teens in the United States aged 15-19 were killed and more than 350,000 were treated in emergency departments for injuries suffered in motor-vehicle crashes. (Centers for Disease Control and Prevention. Web-based Injury Statistics Query and Reporting System (WISQARS). National Center for Injury Prevention and Control, Centers for Disease Control and Prevention (producer) (2009); NHTSA Fatality Analysis Reporting System (FARS), 2008. Washington, DC: U.S. Department of Transportation, National Highway Traffic Safety Administration, National Center for Statistics and Analysis (2009)). Young people ages 15-24 represent only 14% of the U.S. population; however, they account for 30% ($19 billion) of the total costs of motor vehicle injuries among males and 28% ($7 billion) of the total costs of motor vehicle injuries among females. (Finkelstein, E A; Corso, P S; Miller, T R. “Incidence and Economic Burden of Injuries in the United States”. New York: Oxford University Press (2006)). Per mile driven, teen drivers ages 16 to 19 are four times more likely than older drivers to crash. (Insurance Institute for Highway Safety (IIHS). Fatality facts: teenagers 2008. Arlington (Va.): The Institute (2009). Crash risk is particularly high during the first year that teenagers are eligible to drive. (Id.).

When a teenage driver's lack of experience and responsibility is combined with drinking and driving, a lethal combination results. At all levels of BAC, the risk of being involved in a crash is greater for young people than for older people. (Zador P L; Krawchuk S A; Voas R B. “Alcohol-related relative risk of driver fatalities and driver involvement in fatal crashes in relation to driver age and gender: an update using 1996 data.” 61 Journal of Studies on Alcohol 387 (2000)). In 2009, 5,051 teenage drivers with BAC levels of 0.08% or higher were involved in fatal crashes, 18% of all such fatal crashes. (Dept of Transportation (US), NHTSA. “Traffic Safety Facts 2009: Alcohol-Impaired Driving”. Washington, D.C. (2010)). Among male drivers between 15 and 20 years of age who were involved in fatal crashes in 2005, 26% had been drinking. (NHTSA, Dept. of Transportation (US). “Traffic safety facts 2008: Speeding”. Washington, DC (2008a); NHTSA, Dept. of Transportation (US). Traffic safety facts 2008: Young Drivers. Washington (D.C.) (2008b)). During the 30 days before one survey, 41.8% of high school students had drunk alcohol, 28.3% rode in a car or other vehicle driven by someone who had been drinking alcohol, and 9.7% had driven a car or other vehicle one or more times when they had been drinking alcohol. (Centers for Disease Control and Prevention. “Youth Risk Behavior Surveillance-United States, 2009”. National Center for Chronic Disease Prevention and Health Promotion (producer) (2010)).

Still further, compared with other age groups, teens have the lowest rate of seatbelt use. In 2008, nearly three out of every four (75%) teen drivers killed in motor vehicle crashes after drinking and driving were not wearing a seatbelt. (Centers for Disease Control and Prevention. “Youth Risk Behavior Surveillance-United States, 2009”. National Center for Chronic Disease Prevention and Health Promotion (producer) (2010)). There is an obvious need to address this teenage drinking and risky driving epidemic.

While devices exist that attempt to prevent impaired driving, their effect has been limited and have not addressed the teenage impaired driving issue. Vehicle breathalyzer testing and sobriety interlock devices have existed for some time. Several courts throughout the United States now require that interlock devices be placed in vehicles operated by individuals convicted of driving under the influence. Most modern interlock devices include a few common elements: a power supply, a fuel cell (alcohol sensor), a sampling system (a breath intake channel leading to the fuel cell), a microprocessor to analyze the results of the test taken by the fuel cell and an output (a relay connected in series with the starter of the vehicle). These known types of devices work on a principle that the breath of a person who has consumed alcoholic beverages can be sampled to determine the corresponding blood alcohol content of that person. Using known levels of blood alcohol content, the device can determined whether someone has too much alcohol in their system which would affect their ability to operate the vehicle. However, it is a common ploy for an impaired driver to “trick” such vehicle interlock devices so that the impaired driver can operate the vehicle by having a sober accomplice perform the breathalyzer test or by using a gas source other than a human breath, say from a balloon, to fool the device into thinking that an actual test is being made.

Thus, second generation vehicle breathalyzer testing and sobriety interlock devices have attempted to incorporate personal identification. One such attempt utilizes a photographic unit in the substance testing device. However, the device merely takes a photograph (operable) in response to the detection device testing a person who is affected by alcohol. Initially, there is no guarantee that the person who blows into the breathalyzer and has their photograph taken will be the same person who subsequently drives the vehicle. Moreover, this is not necessarily a means to prevent the engagement of a starter mechanism of a vehicle, for example, but instead a monitoring function for review at a later time to see who in fact used the interlock sobriety device—after the damage from an accident has been done. A need has therefore been recognized in connection with providing an effective, foolproof ignition interlock device that precludes loopholes of the types described above.

### SUMMARY OF THE INVENTION

mom In accordance with the principles of the present invention, the teenage drinking and risky driving epidemic is addressed in a cost-effective manner. In accordance with the principles of the present invention, an effective, foolproof ignition interlock device is provided. A monitored ignition lock unit is contained within a vehicle. The monitored ignition lock unit is in communication with a weight sensor in the driver's seat (and optionally the passenger's seat), and seatbelt detection feature of the vehicle. A monitored ignition lock managing system is contained remotely from the vehicle. The monitored ignition lock unit and the monitored ignition lock managing system are in wireless communication. The monitored ignition lock unit includes a handheld device and a receiving station. The handheld device includes a substance detector, such as a blood alcohol content breathalyzer. A camera is aimed to photograph a user when engaged with the substance detector. In one embodiment, a first camera can be contained in the handheld device to get a close-up view of the user and a second camera can be contained in a location, such as for example the driver's side windshield support, to get a wide-angle view of the vehicle's interior. The handheld device and the receiving station are connected via a tether. The tether is sized such that only a driver sitting relatively close to the monitored ignition lock unit receiving station can access the substance detector provided in the monitored ignition lock handheld device. If the user exceeds a predetermined reading from the substance detector, the vehicle is stopped from starting. Whether engine starting is allowed or disallowed, a message can be sent to the monitored ignition lock managing system.

### BRIEF DESCRIPTION OF THE DRAWINGS

FIG. 1 is a schematic of a monitored ignition lock system in accordance with the principles of the present invention.

FIG. 2 is a close up view of a monitored ignition lock unit in accordance with the principles of the present invention.

FIG. 3 is a close up view of a monitored ignition lock handheld device in accordance with the principles of the present invention.

FIG. 4 is a perspective view of the monitored ignition lock handheld device of FIG. 3 in use.

### DETAILED DESCRIPTION OF A PREFERRED EMBODIMENT

In accordance with the principles of the present invention, a monitored ignition lock system is provided. A monitored ignition lock system in accordance with the principles of the present invention stops a vehicle from starting to preclude a driver who has exceeded a predetermined level of a substance such as alcohol in his or her system from driving. A monitored ignition lock in accordance with the principles of the present invention confirms a user's identity. A monitored ignition lock in accordance with the principles of the present invention confirms that a safety belt is connected when a user is sitting is the drivers seat (or optionally a passenger in the passenger's seat) of the vehicle. A monitored ignition lock in accordance with the principles of the present invention provides for remote monitoring of the vehicle. A monitored ignition lock in accordance with the principles of the present invention can optionally prevent use of a cellular phone, both in voice and texting, while the vehicle is drive or reverse.

A preferred implementation of the present invention tests for alcohol use. The legal drinking age in the United States is 21 years old. Thus, no one under the age of 21 should ever have consumed any alcohol and drive. An alcohol monitored ignition lock in accordance with the principles of the present invention stops a vehicle from starting to preclude a driver who has exceeded an adjustable, predetermined level of alcohol in his or her system from driving. This predetermined level for 15-20 year olds can be preselected to ensure a zero tolerance of any alcohol consumption. As the user ages and turns 21, the user is for the first time experiencing the effects of alcohol. Thus, for example, the predetermined level for 21+ year olds can be adjusted to allow a small amount of alcohol consumption, but still significantly under the legal limit. Additional examples where the adjustable, predetermined level of the alcohol monitored ignition lock in accordance with the present invention can be preselected to ensure a zero tolerance of any alcohol could include any vehicle where people are transported, including, for example, bus drivers, school bus driver, driver's education vehicles, ambulance drivers, trains, etc.

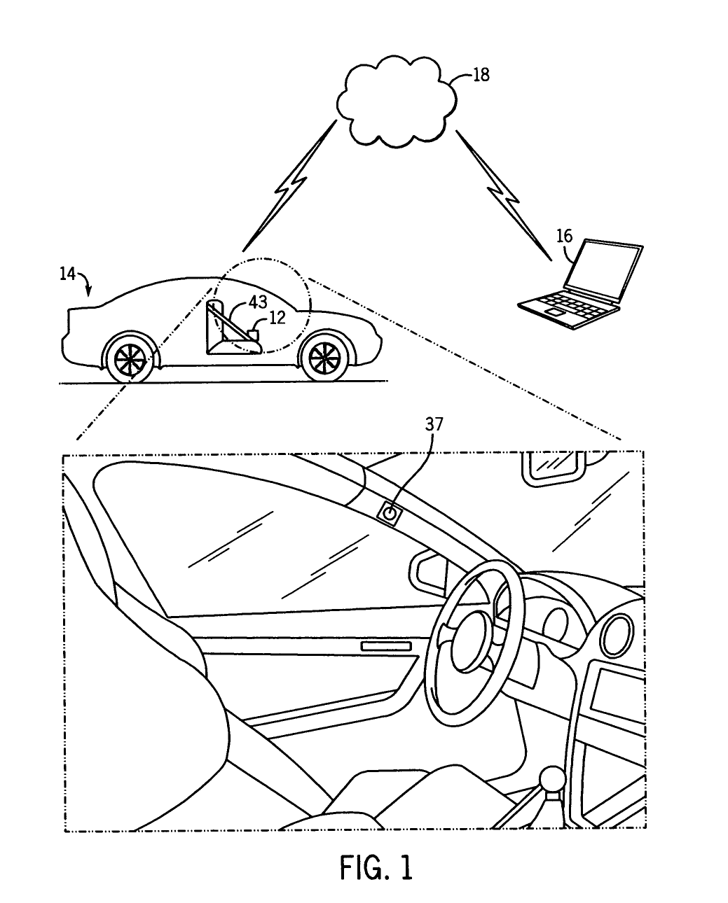

Referring to FIG. 1, a schematic overview of an alcohol monitored ignition lock system in accordance with the principals of the present invention is seen. The alcohol monitored ignition lock system of the present invention includes an alcohol monitored ignition lock unit 12 in a vehicle 14. The alcohol monitored ignition lock system of the present invention includes further includes an alcohol monitored ignition lock managing system contained, for example, in a computer 16 that can be located in a parent or guardian's home or business. The alcohol monitored ignition lock unit 12 and the alcohol monitored ignition lock managing system 16 are in wireless communication with each other thru an access technology 18 such as, for example, Wi-Fi, Universal Mobile Telecommunications System (UMTS), Enhanced Data rates for Global System for Mobile Communications (GSM) Evolution (EDGE) or any other present or future access technology connection. Optionally, the alcohol monitored ignition lock system of the present invention is connected with a Global Positioning System (GPS) 18 which via satellite provides the location of the vehicle 14. This allows personal monitoring for example of the teenage driver by the parent or guardian.

room The user enters into the alcohol monitored ignition lock managing system the identification of each driver of a vehicle so that when a driver enters into a vehicle, the driver is identified. In one embodiment, the alcohol monitored ignition lock managing system assigns each driver with a unique personal identification code or number. In another embodiment, each driver is issued a unique keyless key fob that wirelessly identifies the driver to the system. This key fob can be coded such as for example by color to identify the class of the user, such as above or below the legal drinking age of 21. In a still further embodiment, the key fob can incorporate a breathalyzer to allow a user to pre-check their BAC level before attempting to start the vehicle. This allows a user to avoid failing the vehicular test and disabling the vehicle.

As no one under the age of 21 should ever have consumed any alcohol and drive, the alcohol monitored ignition lock managing system establishes a “zero tolerance” policy for drivers under the age of 21, where the detection of any level of alcohol precludes use of the vehicle. As an optional feature, for drivers over the age of 21 the parent or guardian can set a predetermined alcohol level to allow a small amount of alcohol consumption, but still significantly under the legal limit, because the user is for the first time experiencing the effects of alcohol. In one embodiment, the parent or guardian's personal identification code and/or keyless key fob can be set to override the system.

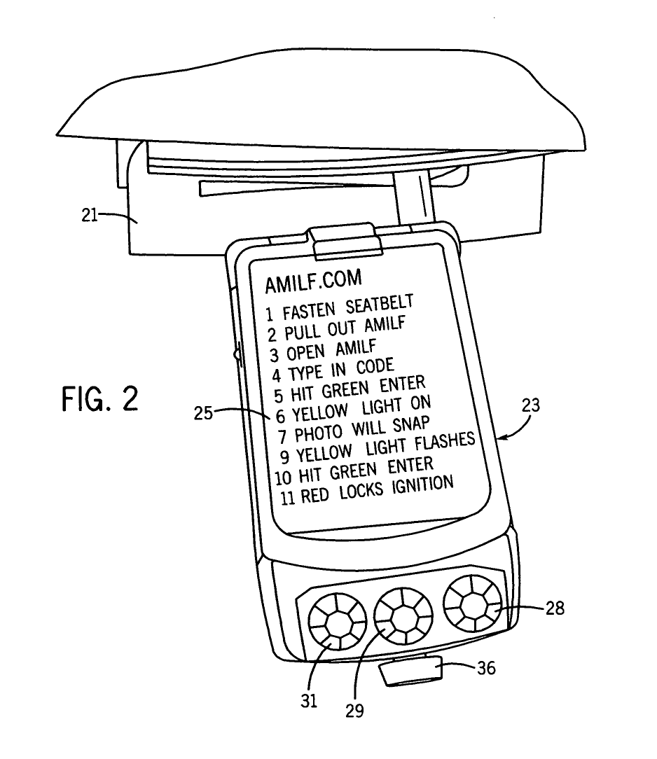

The alcohol monitored ignition lock unit interacts and is in communication with various aspects of the vehicle, including of course an electronic “lock” on operating the vehicle as well as for example the weight sensor in the driver's seat, weight sensors in the additional passenger seats, and seatbelt detection features of the vehicle. Referring to FIG. 2, a close up view of the alcohol monitored ignition lock unit is seen. The alcohol monitored ignition lock unit 12 can include a receiving station such as a docking station 21 and a handheld device 23. The docking station 21 can comprise an add-on unit that is installed onto the dashboard of vehicles or can be built into the dashboard of new vehicles. In one embodiment, the handheld device 23 can comprise a flip-type unit. The handheld device 23 can include a display 25 that can convey using instructions, in this example on the outer cover of the flip-type unit. In one embodiment, the alcohol monitored ignition lock unit 12 can include a cell phone blocking feature to ensure the user does not use their cell phone when the vehicle is in driver or reverse. Again, this feature can be activated or deactivated depending on the status of the driver. In additional embodiments, additional safety features can be added such as, for example, ensuring that all the windows of the vehicle are rolled up.

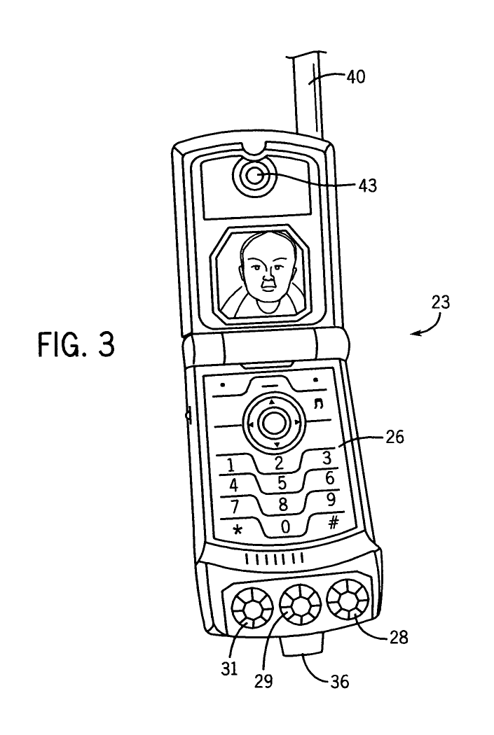

Referring to FIG. 3, a close up view of the alcohol monitored ignition lock handheld device 23 is seen in the open position. Where the user identification is by access code, the handheld device 23 includes a data input device such as for example a keypad entry 26. The handheld device 23 can further include indicators, such as for example a green light 28, a yellow light 29, and a red light 31.

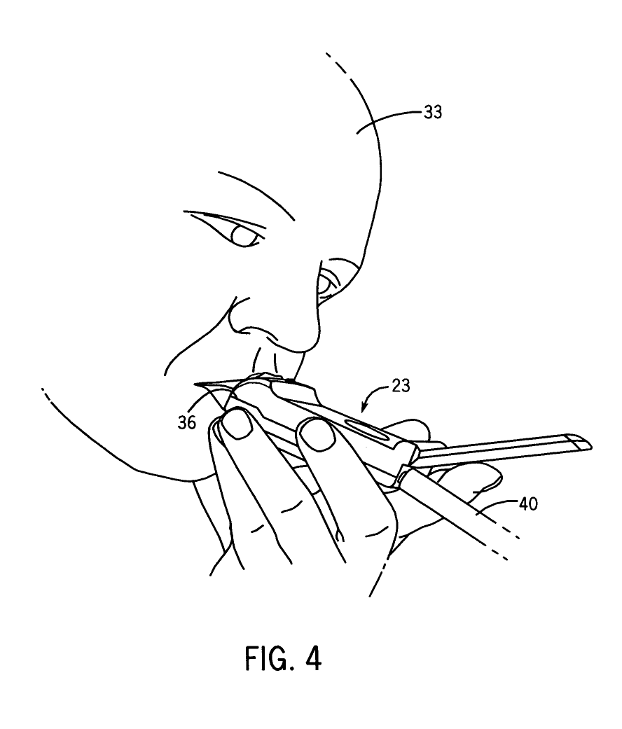

Referring to FIG. 4, a perspective view of the alcohol monitored ignition lock handheld device is seen in operation. In the described example, the alcohol monitored ignition lock unit 23 includes a breathalyzer. The alcohol monitored ignition lock handheld device 23 includes a breathalyzer access port 36 into which a user 38 “blows”. The handheld device 23 is connected to the alcohol monitored ignition lock docking station 21 by a tether 40, as detailed below.

Referring back to FIG. 2, the alcohol monitored ignition lock handheld device 23 can include a digital camera 43 pointed at the location of the alcohol monitored ignition lock handheld access port 36 to get a close-up view of the user. In one embodiment, a second digital camera 37 can be provided in a location, such as for example the driver's side windshield support, to get a wide-angle view of the vehicle's interior, as seen in FIG. 1 and detailed below.

Referring back to FIG. 1, the alcohol monitored ignition lock managing system is downloaded into a home computer 16. The alcohol monitored ignition lock managing system provides a secure wireless access link between the alcohol monitored ignition lock unit 12 in the vehicle 14 and the home computer 16. Each driver of the vehicle is assigned a separate security code (or uses their fob key) by the alcohol monitored ignition lock managing system to be entered into the date entry 26 on the alcohol monitored ignition lock handheld device 23 (seen in FIG. 2) each time the vehicle is used. By issuing a different access code (or uses their fob key) to each driver, the alcohol monitored ignition system of the present invention secures in memory pre-set security items for that user that have been entered into the memory of the alcohol monitored ignition lock managing system. For example, if a parent who has installed the alcohol monitored ignition system of the present invention in a family vehicle enters their security code, the vehicle could be enabled to simply start without any further interaction with the alcohol monitored ignition lock system; if a 17 year old child enters their security code, the pre-set security items for that user are initiated. That way, the parent can avoid potentially embarrassing interaction with the alcohol monitored ignition lock system such as if for example the parent was driving a work associate or client in the vehicle while nevertheless ensuring that their underage child cannot operate the vehicle without engaging with the alcohol monitored ignition lock system.

The alcohol monitored ignition lock system in accordance with present invention prevents a user from starting the vehicle unless the following steps have been completed.

Before any user interaction with the alcohol monitored ignition lock system the user must be seated in the vehicle and the seatbelt 43 fastened. Thus, the alcohol monitored ignition system of the present invention is in communication with the weight sensor in the driver's seat and the seatbelt detection feature of the vehicle (and optionally the passenger's seat). In addition, the tether connecting the alcohol monitored ignition lock handheld to the alcohol monitored ignition lock unit docking is sized such that only a driver sitting relatively close to the alcohol monitored ignition lock unit docking can access the breathalyzer access port provided in the alcohol monitored ignition lock handheld device. While in the example embodiment described herein the tether comprises a physical connection, in future embodiments the tether could comprise a wireless connection calibrated such that only a driver sitting relatively close to the alcohol monitored ignition lock unit docking can access the breathalyzer access port provided in the alcohol monitored ignition lock handheld device. In one embodiment, a second digital camera lens is contained in a location, such as for example the driver's side windshield support, to get a wide-angle view of the vehicle's interior to capture the image of any passengers or to photograph any ungainly attempt made by a passenger to lean over and trick the system. This offers multiple benefits, such as ensuring that drivers utilize their seatbelt and ensuring that the user who interacts with the alcohol monitored ignition lock unit is indeed the driver of the vehicle.

Once the user has secured the seatbelt 41, the user must pull the alcohol monitored ignition lock handheld device 23 from its docking station and enter their access code into the date entry 26 (or use their fob key) on the alcohol monitored ignition lock handheld device 23. This enables the optional cell phone blocking feature and the user cannot send or receive cellular phone calls or texts while in reverse or drive. When user has been identified, if because of the security settings of the user the alcohol monitored ignition system of the present invention is overridden an indication such as for example a green light 28 occurs; when the code has been entered (or the fob key), if the security settings of the user require further interaction with the alcohol monitored ignition lock of the present invention an indication such as for example a yellow light can occurs 29. The user then must blow into the access port 36 provided in the alcohol monitored ignition lock handheld device 23 for a breathalyzer test known in the art, as seen in FIG. 4.

When the user has blown hard enough as measured by the alcohol monitored ignition lock breathalyzer, the alcohol monitored ignition lock camera 43 takes a photograph of the user as the user is blowing into the alcohol monitored ignition breathalyzer access port 36. As this photograph is taken before the test results have been processed, a photograph is taken in every instance, whether the breathalyzer test is passed or failed, to create a record of the person who blew into the device. This photograph, along with the requirement that the user must be seated in the vehicle (as detected by the seat weight sensor) and the seatbelt fastened (as detected by the seatbelt detection feature of the vehicle) help ensure that an impaired driver cannot “trick” the alcohol monitored ignition lock breathalyzer of the present invention by having a sober accomplice perform the breathalyzer test or by using a gas source other than a human breath. In one embodiment, the second digital camera lens captures the image of any passengers. In a future embodiment, the alcohol monitored ignition lock camera can be in communication with a fingerprint reader or a face identification program within the alcohol monitored ignition system of the present invention that has had the fingerprint or face of the user preprogrammed into the memory of the unit to ensure that the user matches the user's security code.

When the alcohol monitored ignition breathalyzer has received a valid breath reading and the user's photograph has been taken, an indication such as for example the yellow light 29 flashing occurs. Either automatically or by a user input, the alcohol monitored ignition lock unit 12 sends the photographs of the user and vehicle interior and the blood alcohol reading from the test to the home computer 16, and optional details such as for example time of the performance and the location of the vehicle as determine by a GPS. If the user passes the breathalyzer test and all these steps have been successfully performed, then the alcohol monitored ignition lock system indicates the vehicle can be started with an indicator such as for example a green light 28. In one embodiment, if a monitored seatbelt is released the driver will have a set period of time to pull the vehicle over and the driver retested to help insure no teenage tomfoolery has occurred during the drive. In additional embodiments the driver can be retested when the vehicle is put in park and when the vehicle is turned off before exiting to help insure no alcohol has been consumed during the drive.

If the user fails the breathalyzer test, then the alcohol monitored ignition lock system indicates the vehicle cannot be started with an indicator such as for example a red light 31. If the user fails the breathalyzer test the alcohol monitored ignition system of the present invention can disable the vehicle for a pre-determined period of time such as for example an hour for that user before another attempt to start the engine can be made. Again, the alcohol monitored ignition lock system sends the results of the blood alcohol reading from the test and photograph of the user to the home computer 16. The parent or guardian is thus given notice of the blood alcohol level of the user and thru GPS the location of the vehicle. Since the vehicle is not in driver or reverse, the cell phone blocking feature is disabled and the user can send or receive cellular phone calls. Optionally, the alcohol monitored ignition lock system can also inform the parent or guardian how long the vehicle will be disabled. In an alternative feature, the alcohol monitored ignition lock system can provide a message of its use via for example a text message to the parent or guardian's cellular phone or personal digital assistant, so the parent or guardian can choose to check the results.

In an optional embodiment, the system may allow the parent or guardian to issue a temporary access code for another licensed driver. This temporary access code can be designated to be enabled after a given period of time such as for example 30 minutes has passed. This other licensed driver must go thru the described steps for the vehicle to become enabled. This could apply to vehicles where people are transported, such as, for example, bus drivers, school bus driver, driver's education vehicles, ambulance drivers, trains, etc.

It should be understood that various changes and modifications preferred in to the embodiment described herein would be apparent to those skilled in the art. For example, while the preferred embodiment has been described herein as for teenage drivers under the legal driving age, other applications can be utilized such as, for example, bus divers, ambulance drivers, train conductors, etc., and even aircraft and boat pilots. In addition, while the preferred embodiment has been described as applied to testing for alcohol consumption, testing for other impairing substances such as for example marijuana, tetrahydrocannabinol (THC) or any other such substance whose presence can be accurately tested is to be considered within the scope of the invention, particularly as technologies for detection of such additional substances is developed. Such changes and modifications can be made without departing from the spirit and scope of the present invention and without demising its attendant advantages. It is therefore intended that such changes and modifications be covered by the appended claims.

What is claimed is:

1. An monitored ignition system comprising:
a monitored ignition lock unit within a vehicle, the monitored ignition lock unit in communication with a weight sensor in a driver's seat and a seatbelt detection feature of the vehicle;
a monitored ignition lock managing system contained remotely from the vehicle, the monitored ignition lock and the unit monitored ignition lock managing system in wireless communication;
the monitored ignition lock unit comprising a handheld device, the handheld device comprising a substance detector;
at least one camera aimed to photograph a user when engaged with the substance detector; and
the handheld device connected to a receiving station via a tether, the tether sized such that only a driver sitting relatively close to the monitored ignition lock unit receiving station can access the substance detector provided in the monitored ignition lock handheld device;
wherein a vehicle is stopped from starting to preclude a driver who has exceeded a predetermined level of substance in his or her system from driving;
further wherein a photograph of the user and the reading from the substance detector is sent to the remote monitored ignition lock managing system.

2. The monitored ignition system of claim 1 further wherein the substance is alcohol.

3. The monitored ignition system of claim 2 further including, if the driver is below the legal drinking age, the predetermined level of alcohol is zero.

4. The monitored ignition system of claim 2 further including, if the driver is above the legal drinking age, the predetermined level of alcohol is above zero but below the legal limit.

5. The monitored ignition system of claim 1 wherein the handheld device further comprises a data entry, the data entry receiving from a driver a personal information code to identify the driver.

6. The monitored ignition system of claim 1 wherein the handheld device further comprises a key fob, the key fob transmitting a driver personal information code to identify the driver.

7. The monitored ignition system of claim 1 further wherein the handheld device comprises a flip-type unit, the flip-type unit including a display on the outer cover that can convey user instructions.

8. The monitored ignition system of claim 1 further wherein the handheld device comprises a camera contained in the handheld device to get a close-up view of the user.

9. The monitored ignition system of claim 8 further wherein the handheld device comprises a first camera contained in the handheld device to get a close-up view of the user and a second camera contained in a location to get a wide-angle view of the vehicle's interior.

10. The monitored ignition system of claim 1 further wherein the handheld device comprises a camera contained in a location to get a wide-angle view of the vehicle's interior.

11. The monitored ignition system of claim 1 further wherein the monitored ignition lock unit includes a cell phone blocking feature.

12. The monitored ignition system of claim 1 further wherein the handheld device comprises a green light indicator, a yellow light indicator, and a red light indicator.

13. The monitored ignition system of claim 1 further wherein if the user fails the substance test, the vehicle is disabled for a pre-determined period of time.

14. The monitored ignition system of claim 1 further wherein a message of use is provided via a text message to a cellular phone or personal digital assistant.

15. The monitored ignition system of claim 1 further including a temporary access code for another licensed driver.

16. The monitored ignition system of claim 1 further wherein the tether comprises a physical connection.

17. A method of regulating use of a vehicle in a monitored ignition system comprising:
inputting into the monitored ignition lock managing system an identification of a driver of a vehicle;
inputting into the monitored ignition lock managing system the age of the driver;
the monitored ignition lock managing system assigning the driver a unique personal identification code;
assigning the driver a substance tolerance level;
at the vehicle, determining the identification of the driver;
at the vehicle, testing the driver for the substance;
comparing the test results with the substance tolerance level;
if a driver's substance content exceeds the substance tolerance level set for that driver, disabling the vehicle.

18. The method of regulating use of a vehicle in an monitored ignition system of claim 17 further including assigning the driver an alcohol tolerance level; at the vehicle, testing the driver for alcohol; comparing the test results with the alcohol tolerance level; and, if a driver's alcohol content exceeds the alcohol tolerance level set for that driver, disabling the vehicle.

19. The method of regulating use of a vehicle in an monitored ignition system of claim 18 further including the monitored ignition lock managing system assigning a driver under the legal drinking age a zero alcohol tolerance level.

20. The method of regulating use of a vehicle in an monitored ignition system of claim 17 further including the monitored ignition lock managing system assigning a driver over the legal drinking age a preset alcohol tolerance level above zero but below the legal limit.
